(19) United States
(12) Patent Application Publication
(10) Pub. No.: US 2006/0116142 A1
(43) Pub. Date: Jun. 1, 2006

(54) Well Behaved SMS notifications

(75) Inventor: Piotr Cofta, Kesgrave (GB)

Correspondence Address: CHARLES G. CALL, 1161 Marlin Court, Marco Island, FL, 34145-5809, US

(73) Assignee: Media Lab Europe (in Voluntary Liquidation), Dublin (IE)

(21) Appl. No.: 11/348,820

(22) Filed: Feb. 7, 2006

(51) Int. Cl. H04Q 7/20

(52) U.S. Cl. 455/466

(57) ABSTRACT

Apparatus for controlling an alert signal produced to notify a recipient when an incoming message is received. The message is received via a communications channel from a message originator. In addition, the message originator also specifies and transmits notification data indicating the manner in which the message originator desires that said recipient be notified of the receipt of said message. Reception preference data is created and stored by the recipient in advance, indicating the manner in which the recipient desires to be notified of the receipt of incoming messages. An signal generator responsive to both the notification data and to the reception preference data produces an alert signal in a manner which accommodates the preferences expressed by both the message originator the said recipient

### FIELD OF THE INVENTION

This invention relates to electronic communication systems and more particularly to mechanisms for alerting recipients to the arrival of incoming messages.

### BACKGROUND OF THE INVENTION

Mobile phones can sometimes annoy persons nearby by ringing and beeping at the worst possible times. They misbehave, and by misbehaving, loose the trust of those who use them and those who are subjected to the unwanted sounds.

In part, the users of mobile phones are to be blamed: every mobile phone permits user to turn off the audible ringing and other sounds created when incoming calls and messages are received, and most mobile phones offer a system of preferences which control the way in which audible alert signals are generated. This system of preferences, however, only expresses the preferences of user who receives incoming calls and messages. The sender has no control over the way in which the recipient is alerted when an incoming call or message arrives.

For example, if an SMS message is being sent to a person in a different time zone, the sender may not wish to have the phone beep loudly when the called party is likely to be asleep. But, if the message is urgent, the sender may wish the phone to ring loudly to alert the recipient, even if he or she is asleep.

### SUMMARY OF THE INVENTION

It is accordingly an object of the present invention to alert the recipient of an incoming message in a way that is socially well-behaved, permitting alert signals to be personalized so that tact and consideration of others can be achieved, instead of indiscriminately creating unwanted and intrusive alert signals when they are inappropriate (e.g., beeping loudly in the middle of a romantic dinner).

Preferred embodiments of the invention take the form of methods and apparatus for notifying a remotely located person when an event occurs. Event notification data is transmitted to the remotely located person on or about the time said event occurs and contains notification information that provides a first indication of the manner in which an alert signal is to be presented in a form perceptible to the remotely located person. Receiving preference data is accepted from the remotely located person to provide a stored second indication of the manner in which said alert signal is to be presented. When the event occurs, the alert signal is then produced in a form that is related to and in part controlled by both said first indication and said second indication.

The event which may take the form of the transmission or receipt of a message, such as a message transmitted using a short messaging service such as a message transmitted using a protocol selected from the group comprising the Short Messaging Service (SMS), the Enhanced Short Messaging Service (EMS), the Multimedia Messaging Service (MMS), or Instant Messaging.

The alert signal is typically an audible signal whose intensity is controlled by both the first indication supplied by the originator of the event and the second indication supplied in advance of the event by the remotely located person who is to be notified of the occurrence of the event. The event notification data supplied by the event originator may further contain audio sound data, image data, or video data which is reproduced as a part of or concurrently with said alert signal.

The event notification data may also include an executable program that is sent to and executed by a processor at a location accessible to said remotely located person. The transmitted program when executed produces or controls the presentation of said alert signal in ways directed by the combined meaning of the preferences expressed by both the sender and the remotely located person.

The alert generation mechanism may further include a sensor for acquiring environmental data indicating the status of the remotely located person on or about the time said event occurs, and manner in which the alert signal is presented is modifying based on said environmental data.

One preferred embodiment consists of a communications device, such as a cellular phone or a hand-held computer, which is capable of receiving messages using one of the “short message services” such as the Short Messaging Service (SMS), the Enhanced Short Messaging Service (EMS), the Multimedia Messaging Service (MMS), Instant Messaging, or one of the probable forms these and similar services will take in the future. The principles of the invention can, however, be applied to control the manner in which a recipient is a notified of the arrival of incoming telephone calls or email messages, or more broadly any other event that is initiated from a remote location and which would benefit from an event notification system that automatically adapts to the desires of both the person who originates the event and the person to be notified when the event occurs.

The communications device utilizing the invention has an input port for receiving an incoming message via a communications channel from a message originator, and further incorporates, or is modified to incorporate, means for acquiring notification data transmitted by the message originator and indicating the manner in which the message originator desires the recipient using the device to be notified of the receipt of said message. The device further includes, or is modified to include, means for storing reception preference data indicating the manner in which the recipient desires to be notified of the receipt of incoming messages. In addition, the device incorporates, or is modified to incorporate, a signal generator responsive to both the notification data supplied by the message sender and to the reception preference data supplied by the message recipient to produce the desired alert signal in a manner which accommodates the expressed preferences of both the sender and the recipient.

These and other objects and features of embodiments of the invention may be better understood by considering the detailed description which follows.

### BRIEF DESCRIPTION OF THE DRAWINGS

In the detailed description which follows, frequent reference will be made to the attached drawings, in which:

FIG. 1 is block diagram illustrating the basic functions performed by one implementation of the invention; and

FIG. 2 is a flow chart depicting the functions performed at the recipient's location to control the character of the alert signals generated when incoming messages arrive.

### DETAILED DESCRIPTION

In preferred embodiments of the invention, notification preferences selected by the sender are associated with messages transmitted to a recipient. These notification preferences are communicated to and control a mechanism which generates an alert signal that is perceptible to the recipient and alerts the recipient to the arrival of the incoming message.

The incoming message may take a variety of forms, including incoming telephone and fax calls, email messages, or any other communication which is transmitted from a sender to a remote recipient, and is particularly useful in connection with existing and evolving “short message services.” As used herein, the term “short message services” refers to messaging interfaces and protocols such as the Short Messaging Service (SMS), the Enhanced Short Messaging Service (EMS), the Multimedia Messaging Service (MMS), Instant Messaging, and the probable forms these and similar services will take in the future.

The specific embodiment of the invention to be described may be used, for example, to control the manner in which the recipient of an incoming SMS or EMS message is informed of its arrival. SMS and EMS message transmission is commonly available on digital cellular networks allowing text messages of up to 160 characters to be sent and received via the network operator's message center to a user's mobile phone, or from the Internet, using a so-called “SMS gateway” website.

SMS is a store and forward system; that is, if the recipient's phone is powered off or out of range, messages are stored in the network and are delivered at the next opportunity. Representative SMS systems are described in U.S. Pat. No. 5,915,222 issued to Olsson et al. (Ericsson) on Jun. 22, 1999; U.S. Pat. No. 6,625,460 issued to Manoj Patil (Nokia) on Sep. 23, 2003; and U.S. Pat. No. 6,760,584 issued to Yu-Cheun Jou (Qualcomm) issued on Jul. 6, 2004, the disclosures of which are incorporated herein by reference.

The Enhanced Short Message Service (ESM), an enhanced version of Short Messaging Service (SMS), allows several text messages to be are clustered together. EMS provides capabilities for more rich messaging features such as sending/receiving ring tones and other melodies/sounds, pictures and animations, and modified (formatted) text, and provides a suitable mechanism for including notification information specified by the sender as described in more detail below. EMS, developed by The 3rd Generation Partnership Project (3GPP), a collaboration of a number of telecommunications standards bodies, has become a widely accepted standard. EMS items can be exchanged between phones irrespective of model or make as long as they support the EMS standard. Non-EMS supportive mobile phones treat a message with EMS items as an SMS text message and only the text is displayed

The arrival of a message at the recipient's location is an “event” that may initiate a process which by which the recipient is notified of the event, either immediately or on a delayed basis, in a variety of ways, depending upon:
(1) notification preference information established at the recipient's location in advance of the event, and communicated to the recipient's location at the time of or before the event; and
(2) receiving preference data established at the receiving location in advance of event.

Both the sender's preferences and the receiving preferences are typically established by human senders and recipients, but may be at least initially established using default values, and may be automatically altered by sensed environmental data, such as the time of day at the receiving location and the location of the sender or recipient.

In some existing systems, SMS and/or EMS messages are frequently sent automatically under program control. For example, some telephone systems can automatically transmit a program generated SMS message to a user-designated cellular phone number to advise the recipient whenever a voice mail message is recorded. Email and paging systems can be configured to transmit SMS messages containing all or part of a received message to a designated cellular phone. When these automated systems are used, the user or system administrator may employ the present invention to specify the notification preferences that are associated with each automatically transmitted message, and thereby control the manner in which recipients are alerted when the transmitted message arrives.

Many mobile phones already incorporate mechanisms by which the phone user can select between a set of notification modes, typically using a menu based option setting mechanism. For example, many mobile phones now permit the user to select from a range of alert types, such as “silent,” “discrete,” “normal,” and “outdoor” and thereby control the volume at which alert signals are produced. Some embodiments of the invention may employ such existing mechanisms for accepting and storing preference data, or may utilize mechanism which provides an enhanced set of preferences. In either case, the mechanism used to alert the recipient to the receipt of the incoming message must be capable of responding to not only the local preference settings established by or for the recipient, but also to the received notification preferences which are established by or for the sender and which are received and processed at the recipient's location.

The sender's preferences or requirements, as expressed by the notification information supplied from the sender, may then be adjusted or overridden by the receiving preferences established by or for the recipient. For example, the notification data received from the sender may be a value that expresses an alert intensity desired by the sender on a scale from 0 (silent) to 5 (very loud) while the recipient's preference setting is selected from settings defined as: (a) silent, (b) discreet, (c) normal and (d) outdoor. A rule-based algorithm produces a result value which attempts to best accommodate the desires of both the sender and the recipient. Thus, for example, a message that includes notification information containing a sender-specified notification level “1” (very low intensity) will be silenced completely if the recipient has selected option “(a) silent” but will be amplified to higher level if the recipient has specified option “(d) outdoor.”

When both the sender's and the recipient's preferences are specified by an integer value, the rules-based processing may consist of a single table-lookup operation in which the sender and recipient preference values respectively specify row and column locations in a data storage table, and the result previously stored at each table cell location is chosen to best satisfy the often dissimilar preferences expressed by the sender and recipient.

Further, the preference settings can be automatically modified by the current state of the environment as perceived at the sending location, the receiving location, or both. For example, the sender might employ a mechanism for automatically increasing the requested alert intensity for messages sent to certain telephone numbers specified by the sender to which more urgent messages are likely to be sent, whereas a recipient may employ a mechanism for automatically reducing the desired intensity during those times of day when the recipient does not wish to be disturbed unless the message has been effectively designated as urgent by a high sender preference setting.

The character of the alert signal presented to the recipient may be controlled in part by the content of the notification information supplied by the sender. The content of the notification information specified by the sender and sent to the alert generation mechanism at the recipient's location, may take a variety of forms, as illustrated by the examples below:
(a) The notification information may include a data value indicating a desired intensity level for the alert message, as previously described.
(b) The notification information may include sound files, such as a music clip or “ring tone” that is reproduced as an alert signal to notify the recipient of the event. For example, an EMS message may contain a short piece of music that is played, or an image file that is displayed, or both, to notify the recipient that the EMS message has arrived. Nokia, Ericsson, Siemens, and other cellular phone manufacturers, allow users to compose ring tones directly on the phone, or to compose and send ring tones to the phone from a source computer using a data cable or an SMS/EMS transmission. The notification information sent from the sender to the recipient may accordingly include not only a directive indicating the desired intensity of the alert signal, but also some or all of the alert signal content, such as a distinctive short musical selection or a recorded voice announcement, which is played at a volume jointly controlled by the preference settings established by the sender and the recipient.
(c) The notification information may include an executable program, such as a Java file, that may be sent from the sender and executed at the receiving location to control the nature of the alert signal in response to (1) notification information from the sender; (2) the recipient's established preference settings; and/or (3) sensed conditions at the receiving location, such as the time-of-day at the recipient's location, or the current location of the recipient (possibly detected by a built-in GPS system). The executable program, whether supplied by the sender or already resident on the receiving device, can determine how an event should be announced. The ability to run a program sent from the sender with the message makes it possible to deliver messages that will behave in ways which are defined by the sender but controlled in part by current conditions at the recipient's location. For example, the message could be accompanied by an executable program that causes it to delete itself if it is delivered later than 10 minutes from the time sent, so that old messages which are no longer relevant need not annoy the recipient. An executable program transmitted with or associated with the message might also check the location of the phone, and control the character of the alert message based on the sensed location without revealing the location of the recipient to the sender, thereby avoiding privacy concerns. Based on conditions sensed at the recipient's location, a transmitted executable program might decide whether or not to alert the recipient, control the way in which the recipient is alerted, and control whether or not the message should be deleted without ever notifying the recipient.
(d) The notification information may include information which identifies the sender, or the sender's location, return address, or any other information that may be evaluated at the recipient location to determine the character of the alert message. Thus, for example, the processing of the notification information at the recipient's location may create a “loud” notification for messages received from specified senders, or specified classes of senders, whose messages are regarded as particularly important by the recipient. In addition, the intensity of alert messages from other designated senders or defined classes of senders may be reduced or silenced based on the received identification information. In this case, the recipient's preference information includes data identifying particular senders, classes of senders, or other data contained in the received notification information, which if matched controls the characteristics of the resulting alert signal.
(e) The notification information may include image or video files which may be used to provide the recipient with a visual alert message, such as a picture or a film clip that identifies the sender. As in the case of “ring tone” and voice audio files, these files may stored locally at the recipients device, possibly from prior transmissions from a sender, and the particular image, video or audio file being designated by one or more file identification values included in the notification information.

Possible Implementations

There are several possible implementations of the invention which permit notification information to be transmitted to the recipient and associated with a message reception event. These implementations include:
1. Employing EMS (Enhanced Message Service) which permits notification data and message content data to be combined, and to define new content types;
2. Employing SIP (Session Initialization Protocol) to transfer the sender's preferences to the receiving device. SIP is widely used for setting up communications sessions on the Internet, such as telephony, presence, events notification and instant messaging. The protocol initiates call setup, routing, authentication and other feature messages to endpoints within an IP domain.
3. For e-mail, transmitting notification information as a MIME (Multipurpose Internet Mail Extension) attachment. MIME is the protocol used to transmit non-text data such as graphics, audio, video and other binary types of files, including executable code such as a Java executable file, within an email envelope.

An Illustrative SMS/EMS Alert Control System

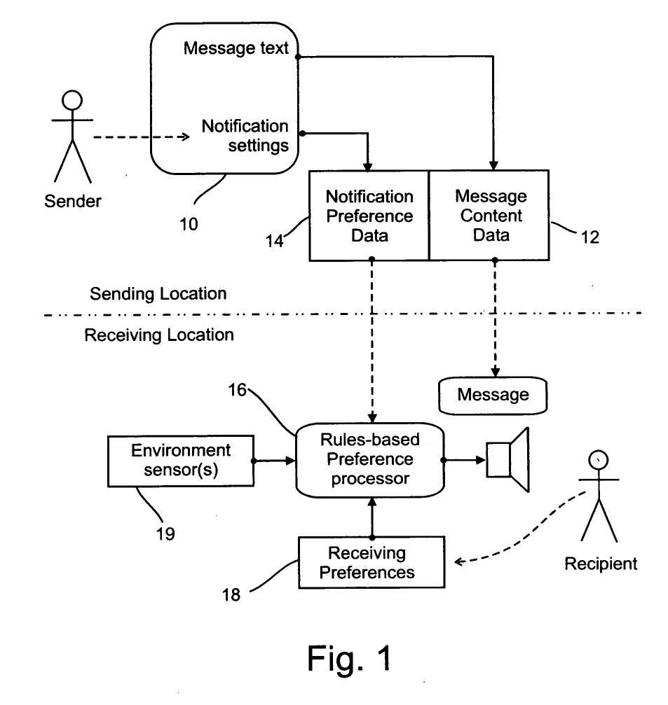

An SMS/EMS implementation embodying the invention employs two functional units illustrated in FIG. 1 using short messages. The implementation requires two parts:

A mechanism seen at 10 at the sending location for accepting notification preference settings from a sender, along with the text of a “short message,” and for transmitting a compound message data structure seen which includes both message content data as indicated at 12 as well as notification preference data as indicated at 14. As described above, the notification preference data may include such things as desired alert intensity levels, ring tone or other audio files, image or video files that may be rendered in a manner perceptible to the recipient, and executable programs, preferably small Java programs, that may perform functions defined by the sender when executed at the receiver when the message arrives.

A mechanism, indicated at 16 in FIG. 1, at the receiving location for processing the notification information 14 in the received compound message, as well as locally stored receiving preferences 18, and possibly also processing environmental data from one or more “sensors” seen at 19 which may include, for example, a GPS position sensor, a clock for indicating the local time of day, or the like. The processing mechanism at 16 executes a rules-based procedure, possibly defined in whole or in part by program code supplied with the message by the sender, that controls the character of the alert signal based on both the notification preference data 14 from the sender, the receiving preferences 18 established by the recipient prior to the receipt of the incoming message, and/or environmental data from the sensor(s) 19 typically obtained on or about the time the message is received.

Most of the mobile devices currently available from major manufacturers can send and receive messages using EMS, the enhanced version of the popular SMS standard. EMS uses specific control characters embedded in the body of the message (in the User Data Header) to convey additional information (e.g. formatting, picture, sound). The implementation may employ a previously unassigned control characters to identify and delimit the “notification information” seen at 14 in FIG. 1 that is embedded in the body of the message. As described above, the embedded notification information may include the specification of an alert intensity level desired by the sender, the content of (or the identification of) audio, image or video files used to generate an alert message perceptible to the recipient, and/or program code that is executed at the recipient's location to control the character and content of the alert.

In addition to providing a transport mechanism (such as the EMS protocol) that can be used to communicate the sender-defined notification information to the recipient, the receiving location must also have the ability to process the received notification information, as well as receiving preferences and locally acquired environmental data, to control the presentation and content of the alert signal that is perceived by the recipient.

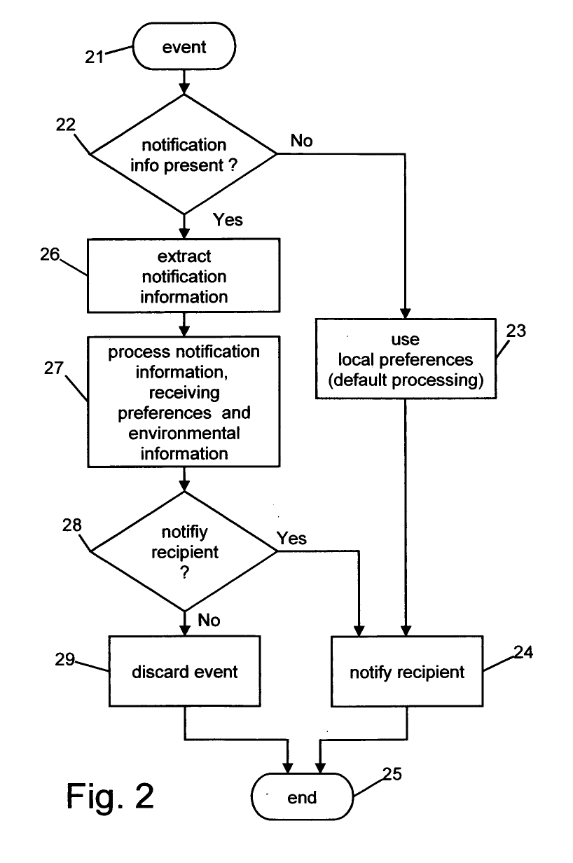

The receiving client interprets and acts upon the sender-supplied data and the conditions at the receiving location in the manner illustrated by the flowchart seen in FIG. 2. Upon the occurrence of an event (typically the arrival of an incoming message) as indicated at 21, the rules based processor (seen at 16 in FIG. 1) makes a test at 22 to determine whether the incoming message contains notification preference data (seen at 14 in FIG. 1). As noted earlier, when EMS messaging is used, the test at 22 may consist of a search for the presence of one or more reserved special characters that are used to delimit and identify the presence of notification information imbedded in the character stream of the incoming EMS message.

If no notification data is present, the receiving device applies the preferences 18 established by the recipient and generates an alert message in the usual way at 24 before exiting at 25. If the presence of notification information from the sender is detected at 22, that notification information is extracted from the incoming message at 26 and the combination of the sender-specified notification settings, the recipient-specified receiving preferences and possibly the environment information are processed as describe above.

If the consideration of both sets of preferences at 28 indicates that the recipient should be notified of the event, that notification occurs at 24 using notification parameters that represent the rules-based result from both sets of preferences. If the test at 28 indicates that the recipient should not be notified, the notification even (but not the message itself) is discarded as indicated at 29.

Both the sender and the recipient should have a convenient method of storing their preferences. If both the sender and the recipient are using hand-held devices like cellular phones, these preferences can be easily entered by using the normal menu-driven device interface employed for entry of other preference data, such as commonly called numbers and volume control settings. As noted earlier, the existing “receiving preferences” already employed to set the desired intensity of alert messages on a receiving device need not be altered in many cases, or may be modified or augmented to make better use of the capabilities provided by the invention.

Some existing mobile devices incorporate development platforms that allow the devices to be readily updated with new installed software to implement the added functionality needed to implement the present invention. In some cases, existing devices may be reprogrammed to support a useful subset of the capabilities available to more advanced system.

### CONCLUSION

It is to be understood that the methods and apparatus which have been described above are merely illustrative applications of the principles of the invention. Numerous modifications may be made by those skilled in the art without departing from the true spirit and scope of the invention.

What is claimed is:

1. A method for notifying a remotely located person when an event occurs comprising, in combination, the steps of:
transmitting event notification data to said remotely located person on or about the time said event occurs, said event notification data containing an indication of the manner in which an alert signal is to be presented in a form perceptible to said remotely located person,
presenting said alert signal in a form perceptible to said remotely located person that is related to and in part controlled by said indication.

2. A method for notifying a remotely located person when an event occurs as set forth in claim 1 wherein said event is the transmission of a message directed to said remotely located person.

3. A method for notifying a remotely located person when an event occurs as set forth in claim 2 further comprising the step of accepting receiving preference data from said remotely located person, said receiving preference data containing a second indication of the manner in which said alert signal is to be presented in a form perceptible to said remotely located person and wherein said step of presenting said alert signal is further controlled in part by said second indication.

4. A method for notifying a remotely located person when an event occurs as set forth in claim 2 wherein said message is transmitted using a protocol selected from the group comprising the Short Messaging Service (SMS), the Enhanced Short Messaging Service (EMS), the Multimedia Messaging Service (MMS), or Instant Messaging.

5. A method for notifying a remotely located person when an event occurs as set forth in claim 1 wherein said alert signal is an audible signal whose intensity is controlled by said indication.

6. A method for notifying a remotely located person when an event occurs as set forth in claim 1 wherein said event notification data further contains audio sound data, image data, or video data which is reproduced as a part of or concurrently with said alert signal.

7. A method for notifying a remotely located person when an event occurs as set forth in claim 1 wherein said event notification data includes an executable program and wherein a processor at a location accessible to said remotely located person executes said executable program to produce or control the presentation of said alert signal.

8. A method for notifying a remotely located person when an event occurs as set forth in claim 1 wherein said alert signal is an audible signal whose intensity is controlled by said indication.

9. A method for notifying a remotely located person when an event occurs as set forth in claim 7 wherein said event is the transmission of a message directed to said remotely located person.

10. A method for notifying a remotely located person when an event occurs as set forth in claim 1 further comprising the step of acquiring environmental data indicating the status of said remotely located person on or about the time said event occurs and wherein said step of presenting said alert signal includes means for modifying said alert signal based on said environmental data.

11. A method for notifying a remotely located person when an event occurs as set forth in claim 10 wherein said environmental data includes data indicative of one or more status conditions selected from the group comprising: the time at which said event occurs; the location said remotely located person; or sensed environmental data captured in the vicinity of said remotely located person.

12. Apparatus for controlling the alert signal produced to notify a recipient when an incoming message is received, said apparatus comprising, in combination:
an input port for receiving said message via a communications channel from a message originator,
a receiver for acquiring notification data transmitted by said message originator indicating the manner in which said message originator desires that said recipient be notified of the receipt of said message,
a memory for storing reception preference data indicating the manner in which said recipient desires to be notified of the receipt of incoming messages, and
a signal generator responsive to both said notification data and to said reception preference data for producing said alert signal in a manner which accommodates the desires of both said message originator and said recipient as manifested by said notification data and said reception preference data.

13. Apparatus for controlling the alert signal produced to notify a recipient when an incoming message is received as set forth in claim 12 wherein said incoming message is transmitted via said communications channel using a protocol selected from the group comprising the Short Messaging Service (SMS), the Enhanced Short Messaging Service (EMS), the Multimedia Messaging Service (MMS), or Instant Messaging.

14. Apparatus for controlling the alert signal produced to notify a recipient when an incoming message is received as set forth in claim 13 wherein said alert signal is an audible signal whose intensity is controlled by both said first indication and said second indication.

15. Apparatus for controlling the alert signal produced to notify a recipient when an incoming message is received as set forth in claim 13 wherein said notification data further contains audio sound data, image data, or video data which is reproduced as a part of or concurrently with said alert signal.

16. Apparatus for controlling the alert signal produced to notify a recipient when an incoming message is received as set forth in claim 12 wherein said notification data includes an executable program and further comprising a processor at a location accessible to said recipient that executes said executable program to produce or control the presentation of said alert signal.

17. Apparatus for controlling the alert signal produced to notify a recipient when an incoming message is received as set forth in claim 12 sensing means for acquiring environmental data indicating the status of said remotely located person on or about the time said event occurs and wherein said signal generator further modifies the manner in which said recipient is notified of the receipt of said incoming message in response to the content of said environmental data.

18. Apparatus for controlling the alert signal produced to notify a recipient when an incoming message is received as set forth in claim 19 wherein said environmental data includes data indicative of one or more status conditions selected from the group comprising: the time at which said event occurs; the location said remotely located person; or sensed environmental data captured in the vicinity of said remotely located person.
